(19) United States
(12) Patent Application Publication
(10) Pub. No.: US 2006/0087805 A1
(43) Pub. Date: Apr. 27, 2006

(54) Computer housing

(76) Inventor: Vahe Massih, Glendale, CA (US)

Correspondence Address: JAMES E. BRUNTON, ESQ., P. O. BOX 29000, GLENDALE, CA, 91209, US

(21) Appl. No.: 10/974,134

(22) Filed: Oct. 25, 2004

(51) Int. Cl. G06F 1/16

(52) U.S. Cl. 361/683

(57) ABSTRACT

The present invention provides a computer housing both functional and attractive in appearance that does not resemble a conventional computer but rather has a unique, attractive non computer-like design generally pyramidal in shape having four generally triangular-shaped side panels that cooperate to define a convenient and readily accessible, cooled interior space for housing the operating components of the computer. The pyramidal housing has a convenient input-output core and is easily accessible for repair, replacement and maintenance of the components yet the housing can be attractively displayed on a desk top or the like with an attractive externally viewable light located proximate the apex of the housing.

### BACKGROUND OF THE INVENTION

1. Field of the Invention

The present invention relates generally to the field of computers. More particularly, the invention concerns a computer having a novel, generally pyramidal shaped computer housing.

2. Discussion of the Prior Art

Traditionally, computer housings, or towers, have exhibited a generally box shaped configuration having interconnected, generally rectangular-shaped top, bottom and side panels. As a general rule, these prior art housings are quite unattractive and are immediately recognizable as computer housings. Access to the interior space of the housing, within which the operating components of the computer are mounted, is obtained by removing one or both of the housing side panels. Removal of the side panels, which are typically held in place by a plurality of screw type connectors, is cumbersome and time-consuming. Additionally, because of the arrangement of the operating components within the tower, maintenance of the computer is often quite difficult. It is these drawbacks of the prior art that the present invention seeks to overcome.

### SUMMARY OF THE INVENTION

It is an object of the present invention to provide a computer, including a computer housing, that is both functional and attractive in appearance. More particularly, it is an object of the invention to provide a computer housing that does not resemble a conventional computer, but rather is of a unique non computer-like configuration so that it can be attractively displayed on a desk top or the like.

Another object of the invention is to provide a novel computer housing of the aforementioned character that is generally pyramidal in shape having four generally triangular-shaped side panels that cooperate to define an interior space for conveniently housing the operating components of the computer.

Another object of the invention is to provide a computer housing of the character described in which the interior space of the housing is readily accessible so that the operating components mounted therewithin can be easily accessed for repair, replacement and maintenance.

Another object of the invention is to provide a computer housing as described in the preceding paragraphs, which includes strategically located cooling fans for efficiently cooling the interior space of the computer housing.

Another object of the invention is to provide a computer housing of the type described, which includes an externally viewable light located proximate the apex of the housing.

Another object of the invention is to provide a computer housing as described in the preceding paragraphs which includes an input-output core.

Another object of the invention is to provide a computer including a computer housing that is of a simple, straightforward, attractive design and one that can be inexpensively manufactured.

### BRIEF DESCRIPTION OF THE DRAWINGS

FIG. 1 is a front perspective view of one form of the computer of the present invention.

FIG. 2 is a rear perspective view of the computer shown in FIG. 1.

FIG. 3 is a rear perspective view similar to FIG. 2, but showing the rear panel of the computer housing removed to permit access to the interior space of the computer housing.

FIG. 4 is a front perspective view similar to FIG. 1, but showing the apex portion of the housing partially broken away and showing the front and side panels of the computer housing removed to permit access to the interior space of the housing.

### DESCRIPTION OF THE INVENTION

As used hereinafter, the following terms will have the following meanings:

“Pyramidal” means a structure that has the general shape of a pyramid, that is, has the shape of a polyhedron having for its base a polygon and having for its sides four generally triangular shaped faces with a common vertex.

“Computer” means a programmable electronic device that can store, retrieve and process data.

“Operating components” means the various components necessary to the operation of the computer, including a power supply, a central processing unit (CPU), a motherboard, random access memory (RAM), a hard drive, a compact disc (CD) drive, and a floppy disc drive.

“Housing” means an enclosure for enclosing the computer operating components.

“Hard drive” means a disc drive used to read and write hard disks, that has rigid magnetic disks rotating about a central axle with associated read/write heads and electronics used to store data.

“Floppy disc” means a small, portable disc coated with a magnetic substance used for storing computer data readable by a computer with a floppy disc drive.

“Motherboard” means the main circuit board of the computer and more particularly, an interconnecting assembly into which printed circuit cards, boards, or modules are connected.

“Input-output core” means that portion of the computer housing used for inputting and retrieving data.

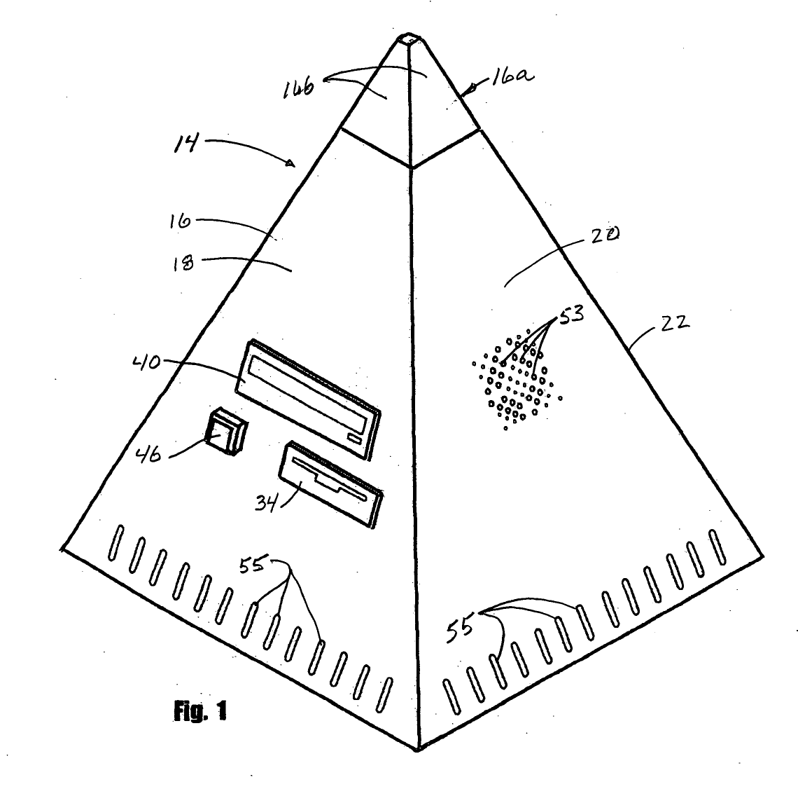

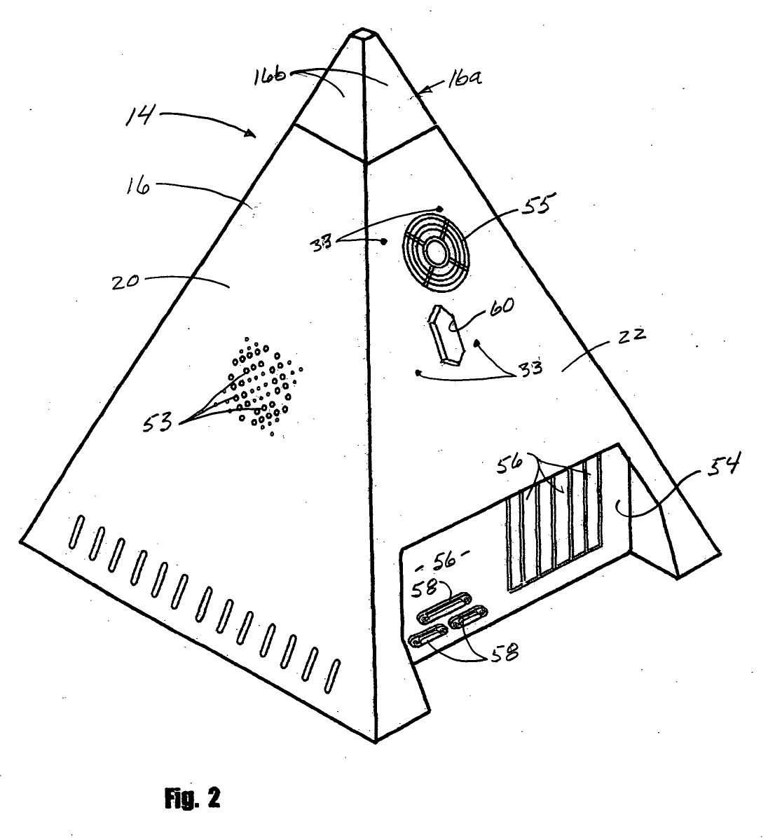

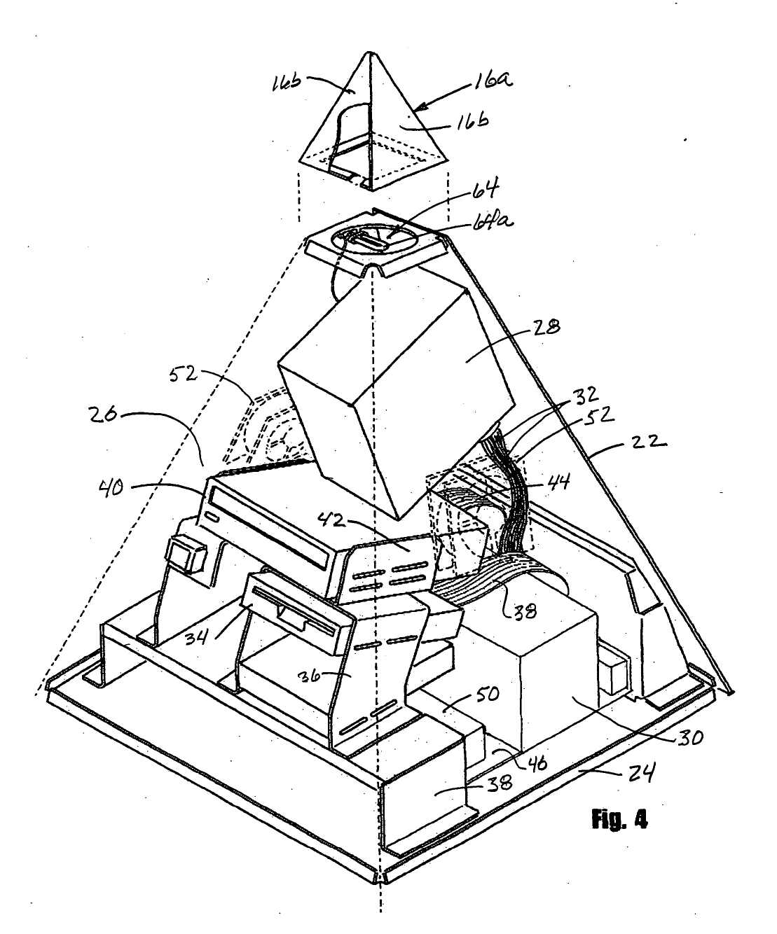

Referring now to the drawings and more particularly to FIG. 1, one form of the computer of the present invention is there shown and generally designated by the numeral 14. As best seen by also referring to FIG. 2, computer 14 includes a uniquely configured housing 16 that is generally pyramidal in shape. Housing 16 includes interconnected, generally triangularly-shaped front, side and rear panels 18, 20 and 22 respectively. Panels 18, 20 and 22 cooperate with a generally rectangular-shaped base 24 (FIG. 4) to define an interior space 26 within which the various operating components of the computer are mounted in a vertically stacked relationship. Panels 18, 20 and 22 can be constructed of various materials including plastic and light weight metal.

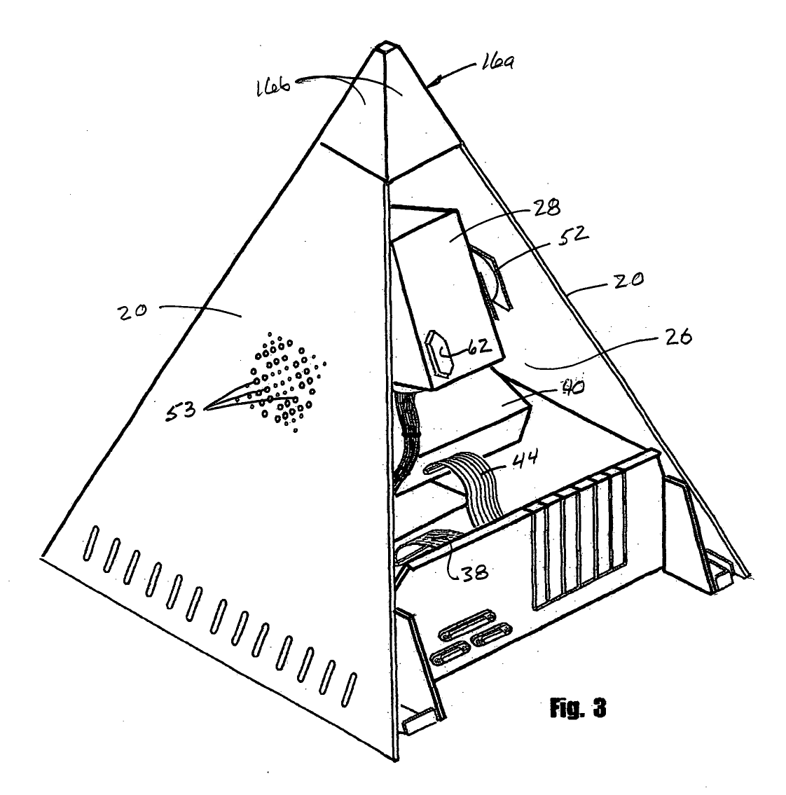

Turning particularly to FIGS. 3 and 4 of the drawings, the operating components of the computer can be seen to comprise a conventional, readily commercially available power supply 28 and a conventional readily commercially available CPU 30 that is interconnected with power supply 28 by suitable electrical conduits 32. Power supply 28 is interconnected with rear panel 22 by appropriate threaded connectors 33 (FIG. 2), while CPU 30 is superimposed over and supported by base 24.

Also mounted within the interior space 26 is a conventional, readily commercially available floppy disk drive 34. Floppy disk drive 34 is supported within the interior space by a specially configured support bracket 36, which in turn is supported by a bracket 38 that is carried by base 24 (FIG. 4). As indicated in FIG. 4, floppy disk drive 34 is appropriately interconnected with CPU 30 by a conventional, readily commercially available connector ribbon 38. A conventional, readily commercially available CD drive 40 is also disposed within the interior space 26 and is held in a superimposed position over floppy disc drive 34 by means of a support bracket 42 that is interconnected with support bracket 36 in the manner shown in FIG. 4. CD drive 40 is interconnected with CPU 30 by a conventional connector ribbon 44. Disposed within interior space 26 and supported by a base 24 is a conventional motherboard 46, which is interconnected with power supply 28 by means of electrical conduits 32.

As illustrated in FIG. 1, floppy disc drive 34 and CD drive 40 are readily accessible via front panel 18 of housing 16. Similarly, a computer-operating switch 46 of conventional construction is mounted on front panel 18 and is readily accessible from the front of housing 16 to commence operations.

Also mounted within interior space 26 is a conventional, readily commercially available random-access memory 50. Random-access memory 50 is superimposed over motherboard 46 and is operably associated with the motherboard and with the power supply 28.

Forming an important aspect of the computer of the present invention are cooling means that are carried by the panels of the housing for cooling the interior space 26 of the housing. In the present form of the invention this important cooling means comprises a pair of commercially available to cooling fans 52, one of which is mounted in one of the side panels 20 and the other of which is mounted in the oppositely disposed side panel 20. Fans 52 draw air into the housing via a multiplicity of openings 53 and 55 formed in the side panels. Also forming a part of the cooling means of the invention is a vent panel 55 that is mounted on rear panel 22 cooling the power supply 28 (FIG. 2).

As best seen by referring to FIG. 2, rear panel 22 of the housing is provided with an input-output core 54 which includes a rearward facing subpanel 56. Formed within subpanel 56 is a plurality of expansion slots 56, which are of conventional construction. In addition to the expansion slots a plurality of conventional cable connectors 58 are mounted on subpanel 56 in the manner illustrated in FIG. 2 of the drawings for use in connecting various types of peripheral devices. As also shown in FIG. 2, rear panel 22 is provided with an opening 60 which is adapted to receive the connector end of a conventional power cord (not shown) for providing power to the power supply via an opening 62 formed in the power supply housing (FIG. 3).

Forming another important feature of the apparatus of the invention is the provision of a light source 64 which is carried in the apex portion 16a of housing 16 and is operably interconnected with the power supply 28. In the present form of the invention, light source 64 includes a small incandescent light bulb 64a (FIG. 4). The sides 16b of the apex portion are preferably constructed from a translucent material so that apex portion is illuminated by the light source. With this construction the illuminated apex functions both as a night light and at the same time comprises an attractive, decorative feature of the apparatus of the invention.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A generally pyramidal-shaped computer housing comprising a base and a plurality of interconnected, generally triangular-shaped panels cooperating to define an interior space.

2. The computer housing as defined in claim 1, further including a cooling fan carried by one of said panels for cooling said interior space.

3. The computer housing as defined in claim 1 in which one of said computer housing is provided with expansion slots.

4. The computer housing as defined in claim 1 in which said panels cooperate to define an apex portion.

5. The computer housing as defined in claim 4, further including a light mounted in said apex portion.

6. A generally pyramidal-shaped computer housing for housing a plurality of operating components, said housing comprising a base and an oppositely disposed apex portion, said housing including four interconnected, generally triangular-shaped panels cooperating to define an interior space, at least one of said panels being removable to provide access to said interior space.

7. The computer housing as defined in claim 6, further including a light mounted within said apex portion.

8. The computer housing as defined in claim 6 in which at least one of said panels is removable to provide access to said interior space.

9. The computer housing as defined in claim 6 in which one of said housing is provided with a plurality of expansion slots.

10. The computer housing as defined in claim 6 further including a cooling fan carried by one of said panels.

11. A computer comprising:
(a) a generally pyramidal-shaped housing having a base and a plurality of generally triangular-shaped panels cooperating with said base to define an interior space;
(b) a power supply disposed within said interior space and interconnected with one of said panels;
(c) a central processing unit disposed within said interior space and operably associated with said power supply; and
(d) a motherboard disposed within said interior space and superimposed over said base, said motherboard being operably associated with said power supply and with said central processing unit.

12. The computer as defined in claim 11, further including cooling means carried by one of said panels for cooling said interior space.

13. The computer as defined in claim 11, further including a random access memory disposed within said interior space and operably associated with said power supply.

14. The computer as defined in claim 11, further including a hard drive disposed within said interior space, said a hard drive being operably associated with said power supply.

15. The computer as defined in claim 11, further including a floppy disk drive operably associated with said power supply.

16. the computer as defined in claim 11, further including a compact disc drive disposed within said interior space and operably associated with said power supply.

17. the computer as defined in claim 11 in which said housing includes an apex portion and in which a light is mounted within said apex portion.

18. the computer as defined in claim 11 in which said housing is provided with a plurality of expansion slots.
